(19) United States
(12) Patent Application Publication
(10) Pub. No.: US 2023/0153878 A1
(43) Pub. Date: May 18, 2023

(54) SYSTEM AND METHOD FOR AUTOMATING PROCESSING OF RESTRICTED ITEMS

(71) Applicant: Grabango Co., Berkeley, CA (US)

(72) Inventor: William Glaser, Berkeley, CA (US)

(21) Appl. No.: 17/989,318

(22) Filed: Nov. 17, 2022

Related U.S. Application Data
(60) Provisional application No. 63/280,534, filed on Nov. 17, 2021.

(51) Int. Cl. G06Q 30/06

(52) U.S. Cl. CPC G06Q 30/0607; G06Q 30/0637

(57) ABSTRACT

A system and method for automating processing of restricted items that can include collecting, using a sensor-based monitoring system, sensor data of user interactions within an environment; processing the sensor data and thereby determining cart items for a virtual cart of a first user; determining a restricted item assertion regarding restricted items intended for purchase by user and presenting the assertion within a user interface of a client device; determining compliance between the restricted item assertion and the virtual cart; and performing digital checkout processing of cart items according to the compliance.

### CROSS-REFERENCE TO RELATED APPLICATIONS

This Application claims the benefit of U.S. Provisional Application No. 63/280,534, filed on 17-NOV-2021, which is incorporated in its entirety by this reference.

### TECHNICAL FIELD

This invention relates generally to the field of automated checkout systems, and more specifically to a new and useful system and method for automating processing of restricted items.

### BACKGROUND

Automated checkout technology is an emerging form of checkout technology that is enabling customers to checkout while avoiding manual entry of items into a checkout system while in the store. Many of these systems use one or more forms of a sensor-based monitoring system such as image-based monitoring systems and/or sensor-enabled shelves.

These systems however can have practical limitations when used in environments that sell various forms of restricted items that may have restrictions or rules that have traditionally required special processing during manual checkout. For example, the purchase of restricted products such as alcohol are often accompanied by shopper identification verification. These practical restrictions have previously limited the scenarios where existing automated checkout technology can be used. Thus, there is a need in the automated checkout field to create a new and useful system and method for automating processing of restricted items. This invention provides such a new and useful system and method.

### BRIEF DESCRIPTION OF THE FIGURES

FIG. 1 is a schematic representation of a system variation;

FIGS. 2-4 are flowchart representations of process variations of a method.

FIGS. 5 and 6 are flowchart representations of exemplary user interaction flows within an application.

FIG. 7 is a flowchart representation of using biometric item authorization.

FIG. 8 is a flowchart representation of a variation with dynamic prompting for an assertion based on restricted item conditions.

FIG. 9 is a flowchart representation variation that prioritizes processing restricted item related sensor data.

FIG. 10 is a flowchart representation of a variation with an exemplary user interface presenting processing status.

FIG. 11 is a flowchart representation of a method variation used for monitoring another checkout system.

FIGS. 12A-12C are flowchart representations of variations using restricted item opportunities.

FIG. 13 is a schematic representation of an exemplary scenario proactively prompting a user to perform item authorization based on a detected user-item interaction.

FIGS. 14A-14C are flowchart representations of variations using restricted item opportunities to reprioritize data processing.

FIGS. 15-17 are flowchart representations of method variations for processing a digital checkout based on compliance.

FIG. 18 is a schematic representation of an exemplary scenario proactively prompting a user to perform item authorization based on a user entering a region with restricted items.

FIG. 19 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for automating processing of restricted items functions to enable automated and/or semi-automated checkout technology in scenarios with possible purchases of restricted items. The system and method can use coordinated assessment of a restricted item assertion and sensed selection of items to automate processing of restricted items.

In one variation, the system and method may coordinate an assertion facilitated through interactions with a network connected client application and a sensed virtual cart determined via a monitoring system in order to automate processing of restricted items. This technological solution can enable a computer-implemented solution for applying a policy around purchase of restricted items.

For example, the system and method in one variation enables a user (e.g., a shopper) to enter within a user application whether they have a restricted item. This may be a step performed while shopping or before leaving a store. If a restricted item is present this can trigger an authorization process, which may be facilitated through a worker device. In the case of purchasing an age-restricted product such as alcohol, the automated checkout system is updated with authorization performed by a client device with an authenticated user that has digital permissions to authorize such purchases -the worker will presumably check a physical ID prior to performing the authorization process. If the user asserts that there are no restricted items, then the system and method may then proceed with determining a virtual cart for the customer, and then verifying that no restricted items were taken. If a restricted item is detected, then that item may trigger some resolution process, which could include the user returning to the store to complete age verification before any purchase of the item is processed.

As another variation, the system and method may additionally or alternatively employ processes to proactively detect events within the environment that can alter a digital checkout processing flow to accommodate different situations related to restricted items. In one exemplary variation, the system and method may automatically make assertions of possible restricted item conditions to appropriately trigger some interaction flow while a customer is in the retail environment. For example, when a customer is detected to have interacted with alcohol in the store, they may be prompted within an app on their phone to see a worker-manned station or otherwise complete age verification. In another exemplary variation, sensor data collected used to determine a customer’s virtual cart may have select subset of data reprioritized within a processing queue so as to interpret data related to restricted items more rapidly. This can change the order data processing for that user but may additionally change the data processing order across all the users in the store, where restricted items may receive heightened priority. This may be used to enable determination of restricted items (possibly in advance of a full cart) such that compliance can be determined before the user leaves the store.

The system and method may be used in combination with automated checkout systems to address the technical challenge of always completing a full virtual cart assessment prior to leaving the store. In some instances, the processing time required to determine a virtual cart from the collected sensor data may be long enough that a full virtual cart is not determined until after the customer leaves the store. The system and method may be used to resolve this technical challenge. In some variations, the system and method can enable a digital interaction flow coordinated between a user digital communicator (e.g., a client application device) and the monitoring system in the retail environment such that no (or at least a minimized amount of) restricted items are included in automated digital transactions without proper compliance.

Several variations and processing flows are presented herein. These variations may be used individually or in combination. In many scenarios, a digital monitoring system may include configuration to selectively execute multiple of the disclosed system and method variations. This can function to enable an automated checkout system to dynamically address the purchase of a restricted items in the best way. For example, an automated checkout system using the system and method may, in one instance, proactively determine if a customer has a restricted item before leaving the store by reprioritizing processing of their associated data, and then in another instance where a restricted item processing can’t be completed in time can have compliance verified and possibly resolved through digital interactions with the customer after the customer has left the store.

System and method variations may also be used as a compliance/monitoring tool in any environment. For example, the system and method may be used in a retail store with worker-stationed checkout stations and/or self-checkout stations. In this case, most items may be processed through the provided checkout systems. However, the system and method may use the checkout transaction record and compare that to a virtual cart assessment in order to detect instances of items not being properly reported or processed. This may be used to identify when customers and/or workers are accidentally or intentionally not accurately reporting the items purchased. A digital resolution process may be used to resolve issues. For example, a credit card or loyalty card identifier may be flagged when an item is detected as not being previously presented for checkout, the user can resolve the issue during a subsequent visit.

The system and method are preferably used in a retail environment. A grocery store is used as an exemplary retail environment in the examples described herein. However, the system and method are not limited to retail or to grocery stores. In other examples, the system and method can be used in supermarkets, convenience stores, shopping stands/kiosks, department stores, apparel stores, bookstores, hardware stores, electronics stores, gift shops, and/or other types of shopping environments. Preferably, the system and method are used in combination with a sensor-based monitoring system used for automated or semi-automated checkout such as the system and method described in U.S. Pat. Application, 15/590,467, filed 09-MAY-2017, which is incorporated in its entirety by this reference. However, the system and method may be implemented independent of any automated checkout process. For example, the system and method may also be used as a compliance monitoring tool to be used in combination with other checkout systems.

The system and method may also be adapted for other applications in environments such as warehouses, libraries, and/or other environments. In this way, the system and method may be used for tracking locations of any suitable type of item or object and is not limited to only products. In general, the items tracked will have some empirical data associated with them which may be empirical data such as an item identifier, but could be any suitable type of empirical data such as an item property.

The system and method may be applied in a variety of areas of application. In one preferred variation, the system and method can be applied to automated and/or semi-automated checkout systems; wherein the system and method facilitate enhanced tracking of product inventory and optionally interactions with the inventory.

Herein, reference to automated is used primarily, but such variations and implementations may similarly be used with semi-automated checkout systems. Herein, automated and/or semi-automated checkout is primarily characterized by a system or method that generates or maintains a virtual cart (i.e., a checkout list) from a shopping experience with the objective of tracking the possessed or selected items for billing a customer. The checkout process can occur when a customer is in the process of leaving a store or after leaving the store. The checkout process could alternatively occur when any suitable condition for completing a checkout process is satisfied such as when a customer selects a checkout option within an application.

The automated checkout system may make use of one or more sensor systems as part of a digital monitoring system. For example, the monitoring system may include image sensors, smart shelves (e.g., with weight sensors, proximity sensors, cameras, etc.), RFID tag system, and/or other monitoring systems. In another variation, a semi-automated checkout system may use human interactions. For example, a customer directed application may have a customer facilitate at least partially entering products into the checkout list. Herein, the use of an image-based computer vision monitoring system is used as an exemplary monitoring system.

The system and method may be used to determine when a customer accidentally or intentionally does not comply with reporting items in their checkout list. In the case of automate checkout, this may be when customers don’t complete age verification when they have an age restricted item. In the case of scan-and-go checkout apps, this may be when customers don’t fully report all items they selected for purchase.

The system and method are preferably used in environments that include a subset of items that have particular restrictions that require or preferably receive special processing. As one example, the system and method can be used with automated management of restricted items such as alcohol, medication, and other items that have age restrictions, quantity restrictions, and/or other forms of restrictions. Such items may need to have the purchaser show proof of ID to purchase an item. The system and method may additionally or alternatively be used for general limitations of items such as high-price items that a store would prefer customers perform some action in order to purchase. The system and method may also be used with items with limited availability and so the store tries to restrict purchases to a limited number per customer. The system and method may also have applications to detect and resolve issues related to partial-cart checkouts (e.g., when a customer or worker only scans sub-set of items that the customer has picked up in the store), shoplifting, inaccurate reporting of carts, and/or other cart reporting issues.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one potential benefit, the system and method can enable automated checkout systems to be used in environments with a mixture of products that are restricted and unrestricted or potentially have different restrictions. Automated checkout systems because they inherently lack the presence of a human worker have traditionally not fit within the traditional approach for processing restricted items (e.g., when a worker asks a customer for their ID during checkout). The system and method include technical solutions to enable automated checkout systems to be used in environments that want to sell restricted and non-restricted items.

As another potential benefit, the system and method can provide a digital verification system that employs user authentication and visual confirmation to enforce a policy regarding special processing of restricted items.

As another potential benefit, the system and method may reduce or prevent violations of policies regarding handling of restricted items. Variations of the system and method can prevent improper processing of restricted items and promote full compliance by an operating store. This may be a technological solution that could be used to achieve policy compliance vastly superior to any human managed solution which is often error-prone and abused. For example, the system and method can reduce or even eliminate instances where a store sells an age-restricted item to an individual without appropriately verifying age.

As another potential benefit, the system and method can use active monitoring state of a user to dynamically trigger user interaction events within a user application and/or alter prioritization of data processing. For example, some variations of the system and method can detect conditions where a potential restricted item interaction may have occurred during a shopping visit. This may be used to alter processing of sensor data so that automated assessment of the sensor data can be performed, optimistically during a shopping trip and prior to completion of a shopping visit. This may additionally or alternatively be used to trigger a user interaction prompt if and when user confirmation within a client application is warranted.

### 2. Method

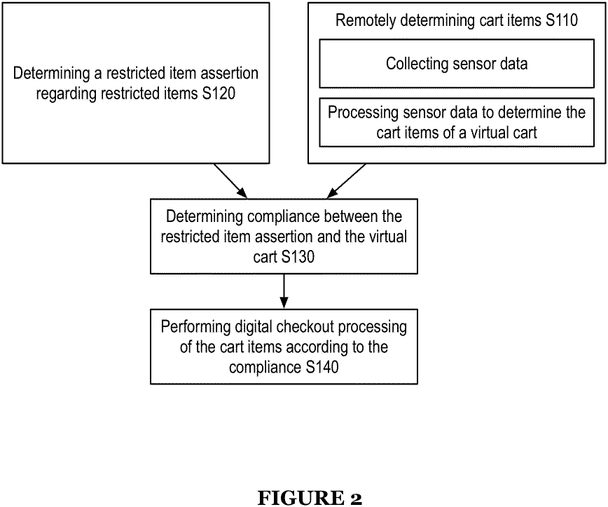

As shown in FIG. 2, a method for automating processing of restricted items can include remotely determining cart items of a virtual cart for a user S110; Determining a restricted item assertion regarding restricted items S120; determining compliance between the restricted item assertion and the virtual cart S130; and performing digital checkout processing of the cart items according to the compliance S140.

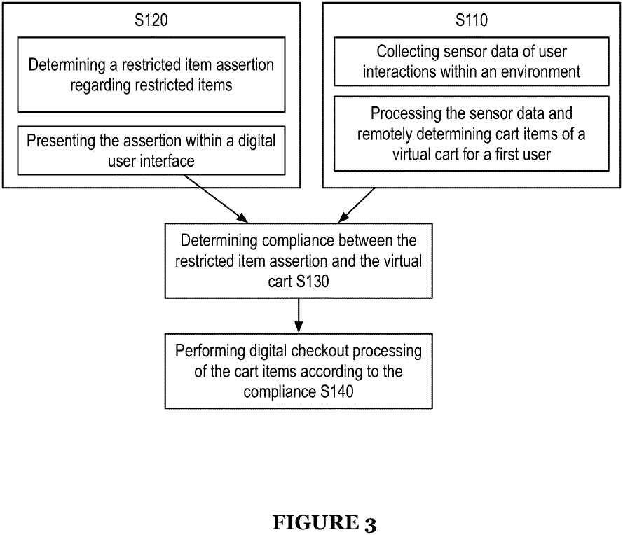

As shown in FIG. 3, one method variation may more particularly include collecting sensor data of user interactions within an environment, processing the sensor data and thereby remotely determining cart items of a virtual cart for a first user (S110), determining an assertion regarding restricted items intended for purchase by the first user and presenting the assertion within a digital user interface (S120), determining compliance between user assertion and virtual cart S130; performing digital checkout processing of cart items according to compliance S140. The presentation of the assertion may be performed through a user interface of a computing device of the user. The presentation of the assertion may additionally or alternatively be performed through a user interface of a computing device installed within the environment such as a computing kiosk that has shared usage across multiple users. The computing kiosk may dynamically display the assertion in response to sensed proximity of the user (e.g., using CV processing) to the computer kiosk, in response to the user badging-in or otherwise prompting the kiosk, or in response to other suitable triggers. The presentation of the assertion may include user input fields to receive the assertion from the user. The presentation may alternatively be a user interface prompt indicating the result of an automated assertion (e.g., saying that restricted item condition was detected, and they need to see a worker or complete some item authorization process).

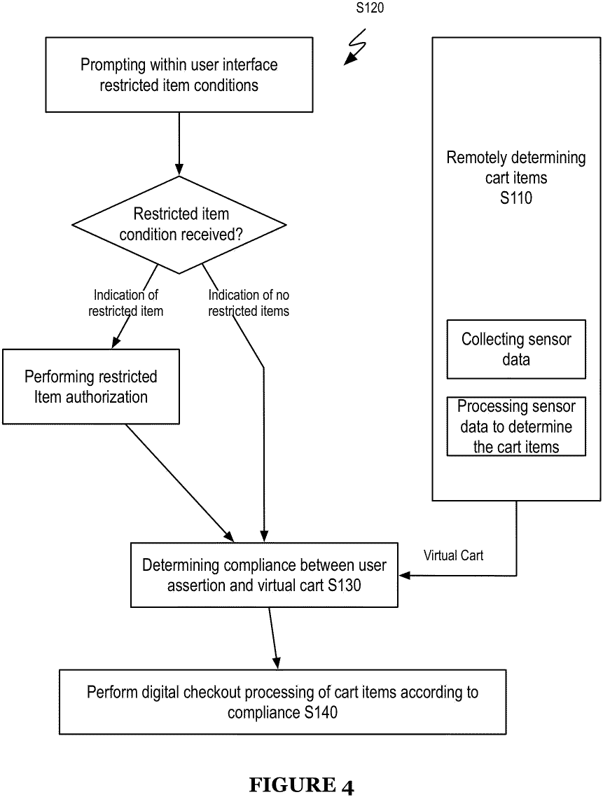

The method enables a coordinated process executed through multiple computing systems that are specifically configured for handling the restricted items. As shown in FIG. 4, the method may be employed such that remotely determining cart items is an ongoing computing process. This process may be executed while a customer is in a store and after the customer leaves the store.

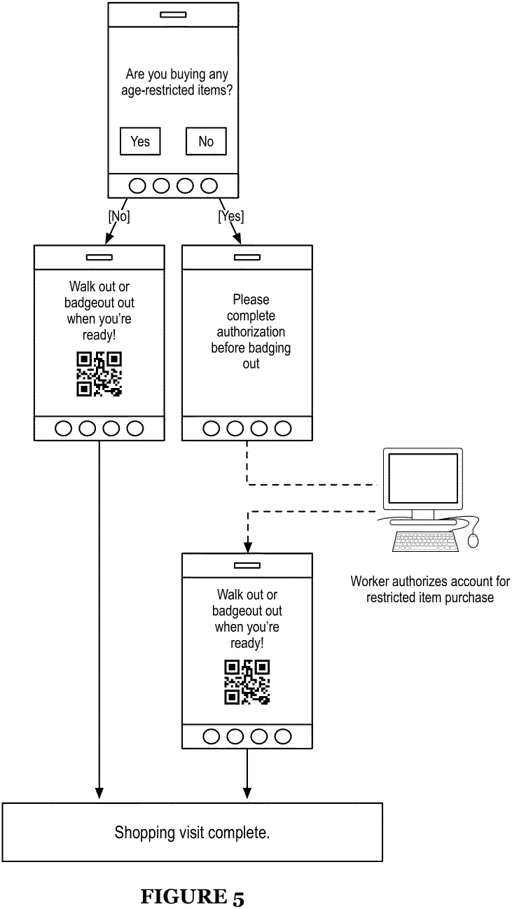

In some variations, an assertion is received through a user interface of a client device. Accordingly, block S120 may include retrieving, within a user interface of a client device, a user-provided assertion regarding restricted items. At some point in such a variation, the method may initiate prompting, through the user interface, for restricted item conditions. This may be presented as a visual or audio interface within a client device of the customer (e.g., a customer’s smart phone or other type of mobile computing device) or an environment-installed computing device (e.g., a badge-out kiosk). This presented interface may be used to guide the customer through different options as shown in FIG. 5.

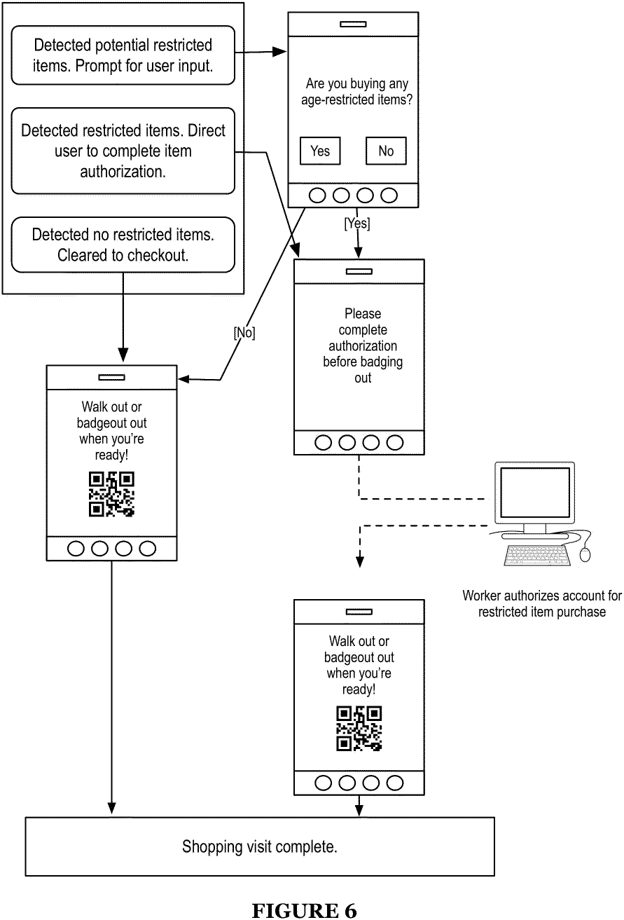

In other variations discussed herein, the method may include processes to automatically determine or otherwise augment the process for asserting if a condition is satisfied that may require item authorization to approve of a restricted item. As shown in FIG. 6, preprocessing of sensor data may be used to dynamically prompt a user based on detected activity of the user while in the store.

In the event that the customer (and/or an automated monitoring system) confirms that a restricted item is present, a user interface may direct the user to complete item authorization. Performing restricted item authorization can involve a worker confirming proof of age via customer’s ID and then entering this item authorization into some computing device (or denying and preventing the purchase of the item). Performing restricted item authorization may alternatively include verifying biometric identification to determine if age-verification is associated with a particular user. Other types of authorization processes may be used depending on the type of policy associated with the item(s).

In the case that the customer submits that there are no restricted items, then the user interface may direct the user to proceed with completing the checkout - in the case of a “Checkout free” system, this can be as simple as leaving with the items or possibly badging out (e.g., scanning a graphical code /QR code or entering a payment mechanism to be used with the checkout process) to complete their shopping period of the shopping visit. When the monitoring system fully or partially completes processing of sensor data to output a checkout list for the customer (i.e., a virtual cart or cart items), then the checkout list can be reviewed to detect if any restricted item was selected for which authorization was not received. In other words, the system can use sensor data to detect if a restricted item was selected and then confirm in the data system of the computing system, if authorization was completed. Checkout processing is performed for the items in compliance. As described herein, items not in compliance may be resolved in various ways, but the items are preferably not charged within the checkout process until and unless authorization is completed. For example, if a customer tries to take alcohol without showing their ID, then it may be detected after they leave the store that they did in fact remove alcohol from the store. This act would be without performing the proper authorization and the system would prevent checkout processing of this item. The non-restricted items, however, may be processed.

The method may be implemented in connection with a variety of types of sensor-based monitoring systems including but not limited to computer vision-based monitoring systems, shelf sensor monitoring systems, smart cart monitoring systems, and/or other types of sensor-based monitoring systems used to automate generation of a checkout list for users in an environment.

In a variation using a CV monitoring system, the method may include collecting image data from a set of imaging devices within an environment, processing the image data and thereby determining cart items selected for a first user as part of a virtual cart as part of block S110. In a variation using a shelf sensor, the method may include collecting shelf sensor data from a set of shelves storing items within an environment, processing the shelf sensor data, and thereby determining cart items selected for a first user as part of a virtual cart. In some variations, the method may include collecting image data from a set of imaging devices within an environment, collecting shelf sensor data from a set of shelves storing items within an environment, processing the image data and shelf sensor data, and thereby determining cart items selected for a first user as part of a virtual cart. Other types of monitoring systems may additionally or alternatively be used such as RFID, NFC, or other remote item monitoring systems.

Through this method, when an assertion is determined (e.g., received via user input or automatically determined) that there are restricted items, then processes for verification and approval of the restricted items may be triggered; and when an assertion is determined that there are no restricted items, then blocks S130 and S140 may be used to appropriately ensure that processing of restricted items is still in compliance.

In the event an assertion is activated indicating a restricted item (or potential restricted item) needs to be processed, the method may include: upon receiving assertion of restricted items, receiving confirmation of age and thereby enabling checkout processing of the restricted items. Other sort of item verification may additionally or alternatively be used such as confirming the number of items purchased by the customer or performing other actions.

In one instance receiving confirmation of age includes receiving age verification confirmation from an authorized device. This may be implemented by the user presenting their ID to a worker, who can then use their worker device to verify their age within the digital data system. This can update a data record associated with the user’s customer cart to indicate that age verification was performed and is approved.

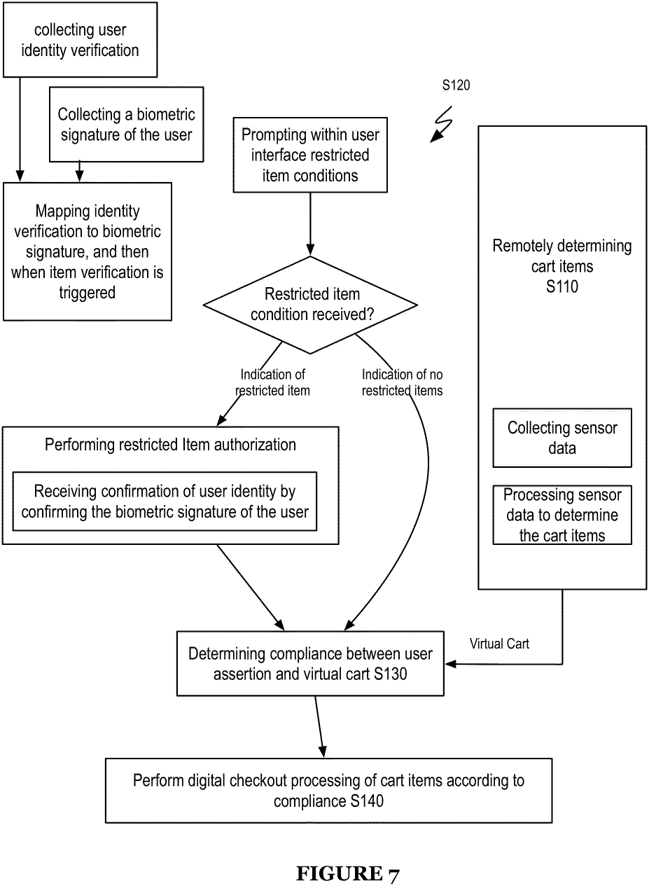

In another variation, a biometric signature of the user may be used to perform age verification (or other forms of identity verification) to approve purchase of a restricted item. Accordingly, in some variations such as shown in FIG. 7, the method may include collecting user identity verification, collecting a biometric signature of the user, mapping identity verification to biometric signature, and then when item verification is triggered, and receiving confirmation of user identity by confirming the biometric signature of the user. The biometric signature may be collected and/or confirmed by performing facial identification, voice identification, fingerprint or handprint identification, retinal identification, and/or other performing other forms of determining a biometric signature. As an example, a user may have an authorized worker or using an automated identity verification service confirm their identity and thereby their age. This may be associated with a biometric signature of the user. Then when the user needs to approve restricted items, they can perform an action to supply their biometric signature. If approved restricted items may be approved for checkout processing.

Accordingly, performing digital checkout processing of cart items according to compliance may include generating a digital checkout cart of items determined to be in compliance and/or triggering a resolution flow for items of virtual cart determined to not be in compliance.

The method may also be used in facilitating resolution of any determined issues regarding compliance. In such a variation, performing digital checkout processing of the cart items according to the compliance can include triggering an out-of-compliance response flow for a set of items out of compliance when compliance indicates items are out of compliance. This may include sending communications to a client device of the user to alert them to issues and/or direct corrective steps. Completion of corrective steps and/or improper completion may be used to update a digital account of the user. This may enable freezing or blocking an account. If a user does complete the corrective steps such as returning to the store to return the item or confirm their age, then the item may be processed for checkout accordingly.

Performing digital checkout processing of the cart item according to the compliance may additionally include triggering approved item processing flow for an approved set of items approved for checkout when compliance indicates the approved set of items are in compliance for purchase. This can include generating a checkout list and then executing digital checkout process to complete a transaction for purchase of approved products.

In one variation, the method may use preemptive data processing to facilitate automated assertion of restricted item conditions. In such variations, the method may use prioritized and/or low latency data processing to quickly determine if a user assertion is necessary.

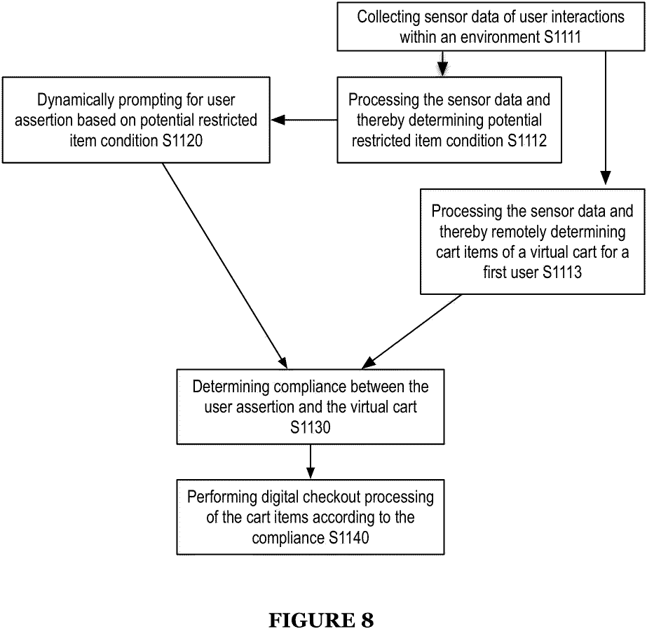

As shown in FIG. 8, such a variation may include collecting sensor data of user interactions within an environment S1111; processing the sensor data and thereby determining potential restricted item condition S1112; dynamically prompting for user assertion based on potential restricted item condition S1120; processing the sensor data and thereby remotely determining cart items of a virtual cart for a first user S1113; determining compliance between the user assertion and the virtual cart S1130; and performing digital checkout processing of the cart items according to the compliance S1140.

In one variation, automated assertion may be used to automatically assert that no restricted items are present when restricted items are predicted to not be present. For example, if a customer never walks in a section with restricted items, then the customer may not need to perform any explicit assertion. The system may still perform subsequent checks (e.g., blocks S130 and S140). Accordingly, in one variation, dynamically prompting for a user assertion may include automatically asserting that there are no restricted items in the virtual cart when indicated by the potential restricted item condition (e.g., there was no or limited chance a user could have selected a restricted item). In this variation, a user may not be prompted to make an assertion. For example, a user interface associated with the user’s virtual cart may present an indicator that no restricted items are detected. The user interface may include a selectable option to override this assertion if it is inaccurate.

In another variation, automated assertion may be used to automatically determine that a user should be prompted to make an assertion. In such a variation, the assertion may still rely on user input, but the user interaction flow of a user interface can dynamically determine if and when such a prompt for an assertion is warranted. Accordingly, dynamically prompting for a user assertion may include automatically requesting user assertion if there is an occurrence of a potential restricted item condition (e.g., there was some chance a restricted item was selected). For example, if a user walks through a wine aisle in a grocery store, the user may receive a push notification via their automated checkout application requesting that the user confirm if their cart includes any alcohol or age restricted items.

In another variation, automated assertion may be used to proactively determine that a user should complete some task for restricted item compliance. For example, when it’s predicted that a user has a possibility of having a restricted item, the user may be instructed to complete some task to complete a shopping experience. This may, for example, allow an automated checkout system to receive age-verification proactively before it is fully determined if they have an age-restricted item. Accordingly, dynamically prompting for a user assertion may include automatically asserting a potential restricted item condition, which is used to trigger a prompt for the user to complete some task to approve the restricted item.

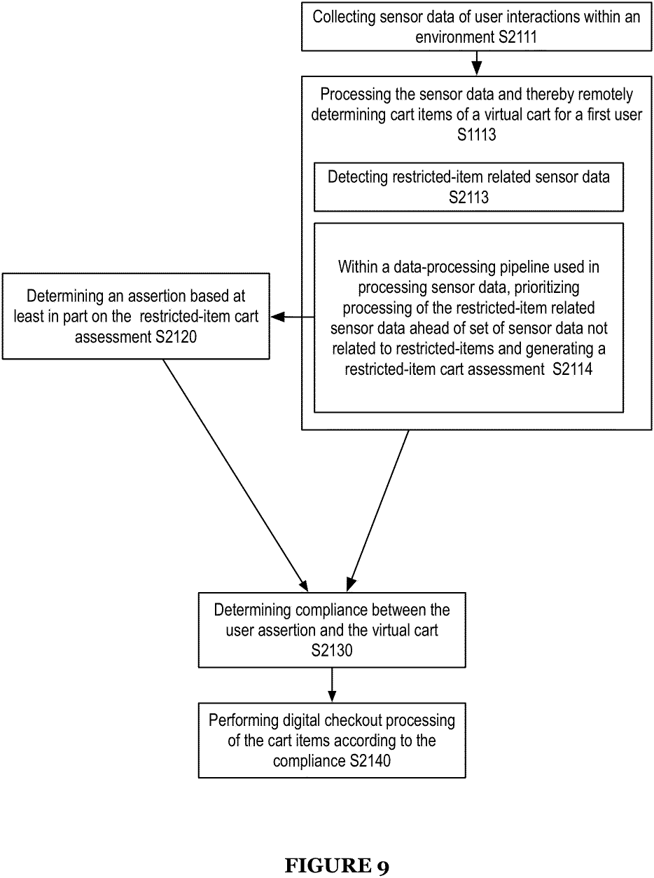

Determining potential restricted item conditions may use data processing outputs that are more feasibly processed and outputted while a customer is still in the retail environment. The Potential restricted item conditions can use data such as user location in the store, user proximity to restricted items, user-item interaction events, and the like. Such potential conditions may additionally or alternatively include sensor-based determination of if a restricted item is part of their cart (similar to the variations shown in FIG. 9).

In one variation, processing the sensor data and thereby determining potential restricted item condition may include: processing the sensor data to determine user location in the environment and determining the potential restricted item condition based in part on user location. For example, a potential restricted item condition may be activated if a customer’s location is determined to have passed through some designated restricted item regions. the customer’s location may be detected using computer vision person tracking, GPS or wireless position tracking, or using other location monitoring techniques.

In one variation, processing the sensor data and thereby determining potential restricted item condition may include: detecting location of user within a proximity threshold to a restricted item. For example, if a user is detected to come within some proximity threshold to a restricted item, then the potential restricted item condition may be activated. This variation can use user location relative to products instead of user location relative to store regions.

In another variation processing the sensor data and thereby determining potential restricted item condition may include: detecting a user-item interaction event that involves the user with a restricted item and activating the potential restricted item condition based the user-item interaction event. For example, if a user picks up a restricted item, then the restricted item condition can be activated. The pick-up of a restricted item does not necessarily mean the user has the item still in their cart, but picking up the item may still be used to trigger requesting the user to assert they aren’t purchasing the item and/or require the user to complete age-verification regardless.

In other variations, the method may be used in altering data processing within a monitoring system to improve performance and/or facilitate an enhanced user interaction with the automated system. In such variations, the method may preemptively process data to assess users for restricted-item conditions. Accordingly, the method may include, as shown in FIG. 9, collecting sensor data of user interactions within an environment S2111; processing the sensor data and thereby determining cart items for a first user S2112 wherein processing the sensor data includes detecting restricted-item related sensor data S2113; within a data-processing pipeline used in processing sensor data, prioritizing processing of the restricted-item related sensor data ahead of set of sensor data not related to restricted-items and generating a restricted-item cart assessment S2114; determining an assertion based (at least in part) on the restricted-item cart assessment S2120; determining compliance between the assertion and virtual cart S2130; performing digital checkout processing of cart items according to compliance S2140. In some variations, block S2130 may be performed after a customer leaves a store when the full virtual cart is determined. In this variation, compliance determination may be accelerated so that block S2130 can be performed while a user is in the store, in which case the user may be more easily instructed how to successfully facilitate checkout processing. This variation can prioritize data processing such that restricted-item related data can be processed before data from a time window occurring first. Detecting restricted-item related sensor data may be based on determining potential restricted item condition such as location, proximity, user-item interaction events, shelf-event data, and/or other data-related events, patterns, or conditions.

Preemptive data processing may be used more broadly for a wide sort of use cases. As discussed, this method may be used for restricted items. This may also be used to more quickly process items based on other properties such as item price, frequency of item shrinkage/theft, item availability levels, and/or other properties.

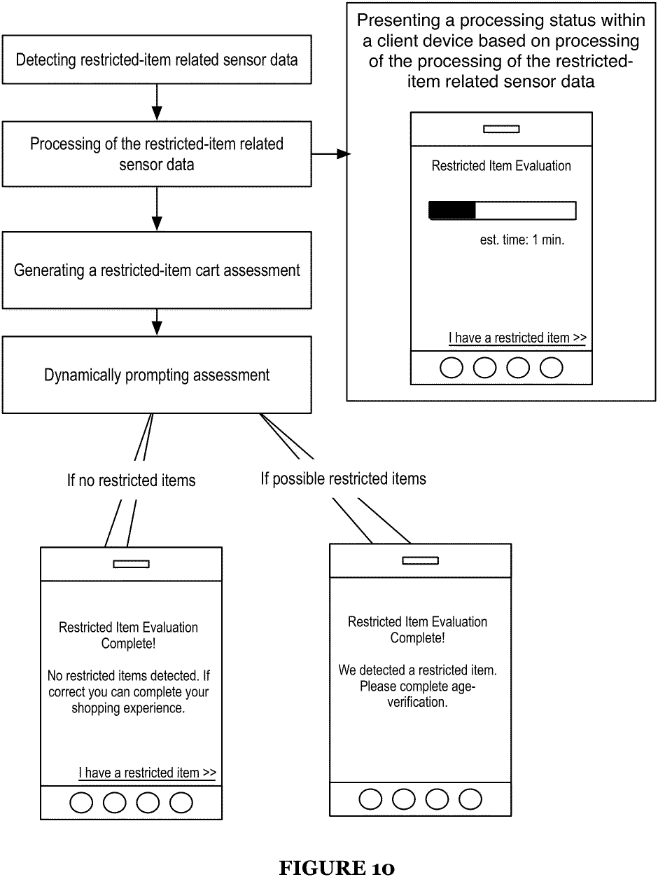

In one variation, preemptive data processing may be used within the digital experience to provide user feedback on the status of their assessment. For example, the method may include processes to display a processing status to indicate when and if they are approved to complete their shopping experience based on compliance assessment. Accordingly, the method may further include, as shown in FIG. 10, presenting a processing status within a client device based on processing of the processing of the restricted-item related sensor data (e.g., an application on a computing device of the user). This may include displaying a “waiting” graphic, a progress bar, or other type of indicator while processing of restricted item related sensor data. As shown in FIG. 10, the processing status may indicate useful information such as an estimated processing timeline for concluding this initial processing. Once processed, the user interface may automatically display a result of the assessment such as: no restricted items, the user may conclude their shopping experience, restricted items found and they need to complete some action (e.g., perform age verification with a worker or using a biometric signature), and/or restricted items found and the user is in compliance with policy for the restricted item (e.g., has completed age-verification

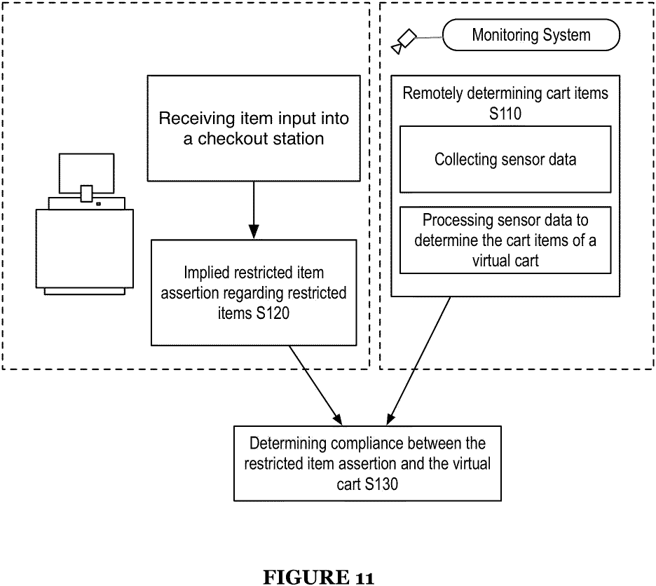

The method may additionally or alternatively be used in connection with other checkout processes including worker-staffed checkout stations, self-checkout stations, scan-and-go self-checkout applications, automated checkout stations, and/or other more manual checkout systems, which may have items accounted for a particular checkout location. In such a method variation, the method may be used as an automated tool for auditing checkout accuracy and/or policy compliance. For example, the method may be used to determine occurrences of partial cart checkouts (not paying for all items), checkout inaccuracies (charging the wrong price), and/or not following policy for restricted items (e.g., verifying age). In such a variation as shown in FIG. 11, the method may more specifically include, determining cart items by receiving item input into a checkout station; determining an assertion regarding restricted items based on received item input (S120), remotely determining cart items of a virtual cart for a user S110, and determining compliance between user assertion and virtual cart S130. In some cases, this method variation may also include steps for further processing cart items according to compliance S140, which may include triggering some flow to facilitate resolution of an issue. For example, if, through the method, it’s determined a customer did not pay for an item, a digital communication may be sent to the user and the item may be billed using a stored payment mechanism. In another example, if, through the method it’s determined a customer did not pay for a restricted item, a digital communication may be sent to the user to complete age-verification in order to properly complete a purchase. This method variation may alternatively be used for generating a report of compliance across the store to identify where patterns of non-compliance occurs. Receiving item input into a checkout station may include receiving scanned item barcodes at a worker station, self-checkout device or app-entry of product codes; and/or using other item entry mechanisms. In this variation, explicit entry of items may also be used in determining an assertion. Receiving no item input of a restricted item is used as an implied assertion that no restricted items are being purchased. In some variations, the user may also be requested to explicitly make an assertion using some app or device. For example, if the method variation is used with a scan-and-go checkout app (e.g., an app where a user walks through store scanning item), the application may prompt the user to confirm that all items have been scanned and/or that no restricted items were purchased.

Block S110, which includes remotely determining cart items, functions to use collected sensor data to assess selection of items by a customer. Determining cart items is preferably performed to determine cart items of a virtual cart for at least a first user but may also be performed simultaneously across multiple users such that a monitoring system is used in determining cart items for multiple users. In one variation, this process may be used in determining a full “virtual cart” that lists all items selected by a customer. In some variations, block S110 may focus on determining only a subset of items. For example, in one variation, the method may be implemented so that only restricted items are monitored for selection.

The cart item output may be determined while a customer is shopping but may alternatively complete after the shopping visit. Additionally, the list of cart items may be periodically or continuously updated during a shopping visit. In the case where a cart is updated prior to exiting the store then the digital interaction flow managed between the remote monitoring system and a client device (e.g., a user device or site-installed computer terminal used by the user) can dynamically adjust based on detected conditions regarding restricted items.

Block S110 may be performed in parallel to the user receiving item authorization. In one variation, the cart is fully completed before evaluation. In another variation, the condition of a virtual cart containing at least one restricted item or having some predicted probability of having a restricted item may be sufficient to alter a digital interaction flow managed between the remote monitoring system and a client device, wherein restricted item authorization can be prompted automatically. This variation may use detection of a restricted item independent of whether the full cart has been determined by the monitoring system.

The process of determining cart items may involve multiple sensor data processing stages with intermediate outputs and/or related data outputs. Such intermediary results may be used in preemptively altering user interaction flows and/or processing of a virtual cart. For example, as part of determining cart item, a monitoring system may perform person tracking, user-item interaction event detection, and/or other processes.

As discussed, the monitoring system may use a variety of sensor types such as image, smart shelves, RFID, and the like. In general, S110 includes collecting sensor data and processing sensor data to determine the cart items. In one variation, block S110 is facilitated by a CV monitoring system which includes collecting image data and processing the image data using a computer vision processing modeling.

Collecting image data across an environment functions to collect video, pictures, or other imagery of a region containing objects of interest (e.g., inventory items). Preferably, collecting image data occurs from a variety of capture points wherein collecting image data includes collecting image data from multiple image capture devices (e.g., cameras) distributed at distinct points in the environment. The set of capture points can include overlapping and/or non-overlapping views of monitored regions in an environment. The set of capture points can additionally establish a high density imaging system within the environment. Alternatively, the method may utilize a single imaging device. The image data preferably substantially covers a continuous region. However, the method can accommodate for holes, gaps, uninspected regions, and/or noncontiguous regions. In particular, the method may be robust for handling areas inappropriate for image-based surveillance such as bathrooms and changing rooms. In these cases, statistical predictions during EOG execution can account for unobservable events.

The image data may be directly collected and may be communicated to an appropriate processing system. The image data may be of a single format, but the image data may alternatively include a set of different image data formats. The image data can include high resolution video, low resolution video, photographs from distinct points in time, image data from a fixed point of view, image data from an actuating camera, visual spectrum image data, infrared image data, 3D depth sensing image data, parallax, lidar, radar, sonar, passive illumination, active illumination, and/or any suitable type of image data.

The method may be used with a variety of imaging systems, and collecting image data may additionally include collecting image data from a set of imaging devices wherein each subset is collected imaging devices in at least one of a set of configurations. The imaging device configurations can include: an inventory storage capture configuration, an interaction capture configuration, an object identification capture configuration, a movable configuration, a blended configuration, and/or any suitable other type of configuration. While an imaging device may be primarily set for one or more configurations, an imaging device may be used for any suitable purpose. Imaging devices mounted over-head are preferably in an aerial capture configuration and may be used as a main image data source. In some variations, particular sections of the store may have one or more dedicated imaging devices directed at a particular region or product so as to deliver content specifically for interactions in that region. In some variations, imaging devices may include worn imaging devices such as a smart eyewear imaging device. This alternative movable configuration can be similarly used to extract information of the individual wearing the imaging device or other observed in the collected image data.

Processing, using a computer vision processing model(s), the image data (and possible additional data) functions to generate image-based information from the image data. Generating product event location data can include performing CV processing of the image data and/or any other suitable type of automated image analysis. The processing of the image data can be used in generating a virtual cart or at least detecting if a restricted item was selected by a customer or potentially interacted with by a customer.

Various techniques may be employed in processing image data using computer vision processes or models such as a “bag of features” object classification, convolutional neural networks (CNN), statistical machine learning, or other suitable approaches. Neural networks or CNNS such as Fast regional-CNN (r-CNN), Faster R-CNN, Mask R-CNN, and/or other neural network variations and implementations can be executed as computer vision driven object classification processes or models that when applied to image data can perform detection, classification, identification, segmentation, and/or other operations. Image feature extraction and classification and other processes may additionally use processes like visual words, constellation of feature classification, and bag-of-words classification processes. These and other classification techniques can include use of scale-invariant feature transform (SIFT), speeded up robust features (SURF), various feature extraction techniques, cascade classifiers, Naive-Bayes, support vector machines, and/or other suitable techniques. The CV monitoring and processing, other traditional computer vision techniques, deep learning models, machine learning, heuristic modeling, and/or other suitable techniques in processing the image data and/or other supplemental sources of data and inputs. The CV monitoring system may additionally use human-in-the-loop (HL) processing in evaluating image data in part or whole.

Collecting image data is preferably accompanied by processing the image data for information extraction. This may include classifying objects from the image data, tracking object locations in the environment, detecting interaction events. These processes may be used in other areas of CV processing in the method. With respect to monitoring inventory and user interactions with inventory, CV processing can include: classifying product items from the image data from within the retail environment; tracking user location in the environment; and detecting user-item interaction events. The method may additionally include tracking a checkout list according to object classifications, user location, and the detected interaction events. This may be performed as part of automated checkout. However, this could also be used in tracking and detecting if and when products are purchased. Monitoring commerce activity preferably includes iteratively processing the image data and applying various image data analysis processes.

Results generated during a customer’s shopping experience may be used to augment the interaction flow such as by dynamically asserting that a customer has a restricted item and should complete age-verification (or any approval process) prior to leaving the store, by dynamically asserting that a customer does not have a restricted item (or has low chance of having such a restricted item), and/or by dynamically prompting the user to confirm or deny if they have a restricted item if there was an opportunity for a restricted item.

Processing the image data may be performed in real-time in response to the occurrence of some event like a person moving through an environment, a person performing some action, the state of a product on a shelf changing, and/or any suitable state of the image data. The method may involve multiple image analysis processes that are used in combination to output some result. For example, the method may include user tracking (tracking location of a user through an environment), event detection (detecting when and where an action like an “item selection” was performed), and product identification (determining the identity of a product) for example. Different processes may have different latency levels. As such, in some cases, generation of a full virtual cart may have a latency that puts its completion after a customer leaves a store. The system and method can address any latency concerns as it relates to restricted products.

Classifying objects from the image data functions to perform object detection. Objects are detected and classified using computer vision or other forms of programmatic heuristics, artificial intelligence, machine learning, statistical modeling, and/or other suitable approaches. Object classification can include image segmentation and object identification as part of object classification. Resulting output of classifying objects of image data of a single image or video stream can be a label or probabilistic distribution of potential labels of objects, and a region/location property of that object. Classifying objects in a single image of the image data can yield multiple object classifications in various regions. For example, an image of a shelf of products with a shopper present can yield classifications for each visible product, the shelf, and the shopper. Specifically, classifying an object, in the context of items on a shelf space or display can include identifying a product identifier for a detected product.

Various techniques may be employed in object classification such as a “bag of features” approach, convolutional neural networks (CNN), statistical machine learning, or other suitable approaches. Neural networks or CNNS such as Fast regional-CNN (r-CNN), Faster R-CNN, Mask R-CNN, and/or other neural network variations and implementations can be executed as computer vision driven object classification processes.

Image feature extraction and classification is an additional or alternative approach, which may use processes like visual words, constellation of feature classification, and bag-of-words classification processes. These and other classification techniques can include use of scale-invariant feature transform (SIFT), speeded up robust features (SURF), various feature extraction techniques, cascade classifiers, Naive-Bayes, support vector machines, and/or other suitable techniques.

Additionally, multiple variations of algorithmic approaches can be implemented in accounting for particular classes of object classification. A hierarchical classification process can be used in iteratively refining classification and/or bounding the classification challenge for enhancing classification confidence and/or speed. In one variation, classifying objects can be limited or isolated to updating based on changes in image data. In one variation, classifying objects of image can be limited to subregions of the image data satisfying a change condition. For example, an image of a shelf of products with a shopper in the lower right quadrant of the image may only have object classification executed for a region within that lower right quadrant, which can alleviate the method from reclassifying products that are static in the image data.

In some variations, object classification can be actively confirmed or informed through another data input channel. For example, a calibration tool may be used for logging an object with a confirmed classification (e.g., a SKU identifier), location, and time.

Classifying objects preferably includes identifying a product identifier for visible products. The product identifier may be SKU or data record of a product, which may include various pricing information that can be used in adding the item as an invoiced item if selected. The product identifier can additionally be used in retrieving product related information. In one variation identifying a product identifier may be used in querying product information from a product information database. Information such as product type, classification, manufacturer, product attributes (e.g., organic, gluten free, etc.) can be retrieved which may be used in determining how the product relates to neighboring displayed products and/or how other products would relate to it. Additionally, the product identifier can be used in querying transaction data to determine the sales data for a particular product. Tracking of sales data as a function of stocking display can be used to determine, predict, or otherwise assign a value to a various shelf face properties (e.g., a specific shelf position and arrangement, or general placement properties).

In particular, product classification or identity may be used to determine which items have restriction policy associated with them. Accordingly, implementing the method can include identifying the products selected by a user and determining if one or more of the products are restricted products.

Tracking objects in the environment functions to monitor the location of an object in establishing an object path. Tracking an object can include tracking the object within image data from a single image capture device but more preferably tracks the object across image data from multiple image capture devices. Tracking an object can additionally be used in identifying and associating objects across image capture devices.

Tracking objects in the environment can, in some variations, include tracking people (i.e., users) in the environment. Tracking users functions to maintain association of a user with collected payment mechanism and/or vehicle station. Tracking objects in the environment may additionally be used in tracking items as they move through the store and their association with a user, which can signal an intention to purchase.

Tracking an object can include applying CV-based object tracking techniques like optical flow, algorithmic target locking and target re-acquisition, data-driven inferences, heuristical processes, and/or other suitable object tracking approaches. In the case of person tracking a variety of person tracking techniques may be used. CV-based object tracking and algorithmic locking preferably operate on the image data to determine translation of an object. Data-driven inferences may associate objects with matching or similar data features when in near temporal and spatial proximity. “Near” temporal and spatial proximity can be characterized as being identified in a similar location around the same time such as two objects identified within one to five feet and one second. The temporal and spatial proximity condition could depend on various factors and may be adjusted for different environments and/or items. Objects in near temporal and spatial proximity can be objects observed in image data from a neighboring instance of image data (e.g., a previous video frame or previously capture image still) or from a window of neighboring instances. In one variation, a window of neighboring instances can be characterized by sample count such as the last N media instances (e.g., last 10 video or still frames). In another variation, a window of neighboring instances can be characterized by a time window such as media instances in the last second.

Detecting interaction events functions to identify and characterize the nature of changes with at least one object. Interaction events can be detectable changes observed in the image data. Preferably, interaction events can be used in applying compound object modeling and multi-state modeling. An interaction event can additionally include triggering updating the checkout list.

Detecting an interaction event preferably includes detecting a user-item interaction which can be CV-based detection and/or classification of an event observed in the image data involving interactions of a user with a monitored object. Monitored objects preferably include products for purchase and/or items for use.

Detecting user-item interactions may include: detecting a user selecting a product and thereby adding the associated item to the checkout list and optionally detecting a user deselecting of (e.g., setting down) a product and thereby removing the associated item from the checkout list. In the variation, where the method is detecting if a user has some possibility of having a restricted item, detecting the user having some interaction with a particular item may be sufficient to trigger needing to request a user assertion or automatically asserting that a restricted item is confirmed or possible. Detecting user-item interactions for usage-based interactions may include detecting use or consumption of an item. Detecting usage may include actions such as detecting dispensing of a drink from a drink machine or making use of amenities such as a waiting room or watching media.

Furthermore, detecting user-item interactions may include detecting directed user attention, which can include estimating user pose and attention relative to a product and/or shelf space location.

In some cases where the method includes tracking and use of performance metrics, detecting user attention may be used to count the number of customers/users that viewed a product and/or the duration of customers viewing a product for example.

As discussed, in some variations the method may be used in combination with other processes for generating a checkout list, wherein the method may be used more to audit and monitor compliance instead of facilitating the checkout transaction. In such variations, determining cart items may additionally or alternatively include receiving item input into a checkout station. The evaluation of cart items using a monitoring system may still be performed but more as a reference to evaluate the items entered at the checkout station. Receiving item input may include receiving barcode scanning input, product code input, or other forms of entering product items to generate a checkout list. The checkout station could be a worker-stationed checkout station and/or a self-checkout station. The checkout station may also be an automated or semi-automated checkout station that automates entry of items at the location of the checkout station (e.g., reading RFID tags, visually identifying, etc.) The checkout station may also be a scan-and-go self-checkout application that a customer uses to enter items using a personal computing device as they shop. The received item input is preferably used in executing a transaction at the conclusion of a shopping experience. However, cart items determined using a monitoring system may be used to create a second type of checkout list that may be used to assess and possibly address issues in that checkout process.

Block S120, which includes determining a restricted item assertion regarding restricted items, functions to collect or determine some indication of a restricted item being present or not for a user. In one preferred variation, determining the restricted item assertion includes retrieving user assertion regarding restricted items, which can use a user interface (e.g., on a personal device of the user or a computing device provided within the environment) to receive a user’s input to assert if restricted items are in a cart or not. In other variations, determining a restricted item assertion may include processing the sensor data and thereby determining potential restricted item condition; and then dynamically determining restricted item assertion based in part on potential restricted item condition (which may, for example, include dynamically prompting or automatically setting an assertion). Such an assertion or condition regarding possession of a restricted item (made by a user or automatically determined) may be used to appropriately insert an interaction stage within processing of the virtual cart so that authorization can be collected.

As indicated for some variations, this assertion may be performed as a user assertion. A user assertion can be retrieved within a user interface of a client device. Accordingly, retrieving the user assertion can include prompting for user confirmation of restricted item conditions. Prompting can include displaying, playing or otherwise presenting a user interface with inputs that correspond to an option indicating one or more restricted items are selected or intended for purchase during the shopping visit and an option to indicate that no restricted items are selected or intended for purchase. Correspondingly, block S120 can include receiving input on the restricted item conditions for the user.

The client device could be a customer client device such as a smart phone, a smart watch, smart headphones, or other network connected mobile computing device. The client device may alternatively be a shared environment-installed computing device such as a checkout kiosk. For example, when completing a shopping visit, a user could approach a store computer kiosk to finalize the visit. This may include answering the restricted item prompt, optionally having a worker authorize restricted items for purchase, and then in some variations supplying payment information so that it can be applied to the checkout processing or performing any other action.

As shown in FIG. 5, block S120 can involve triggering different user interfaces within a client device depending on conditions. For example, if a user has picked up an alcoholic item, then the user can select an option to indicate they have an alcoholic which triggers an authorization process by a worker.

If a user confirms that a restricted item is present the method process can include triggering authorization processing. Accordingly, the method may include, in some variations, upon receiving assertion of restricted items, receiving confirmation of age and thereby enabling checkout processing of the restricted items. Triggering the authorization processing can include alerting a worker. For example, some audio, visual, haptic or other form of alert may be triggered to notify a worker to perform some authorization action. Authorizing involves a worker performing any actions to enable purchase of the restricted item. In one variation, a worker can authenticate within a device (e.g., logging in to their account or supplying some token confirming their identity) and then confirming authorization for one or more restricted items for a user. In some cases, this may include confirming some information that can be applied to any set of restricted items. For example, the worker may confirm proof of age via an ID, which can authorize purchase of any age-restricted item. This may be used to authorize checkout processing for items currently in possession of a user, but may additionally or alternatively authorize checkout processing for potential future items the user selects. For example, the method could enable a user to confirm their age anytime during their visit and then select their alcoholic items before or after this authorization.

In some variations, authorizing can include performing automated authorization. This may enable an automated system to facilitate the authorization process. For example, a system could scan a ID card, confirm age, and then perform some confirmation that the ID card corresponds the user. For example, biometric signature such as fingerprints, facial properties, eye properties, gait properties or other suitable biometric signals may be used to confirm an ID is uniquely associated with the user performing the shopping visit. Accordingly, the method may include collecting user identity verification, collecting a biometric signature of the user, mapping identity verification to biometric signature, and then when item verification is triggered, and receiving confirmation of user identity by confirming the biometric signature of the user at the time of item authorization.

If the user has not picked up an alcoholic and/or other restricted item, then the user can select an option to indicate they have no restricted items, which then permits completion of their shopping visit without enforcing an authorization process. As detailed herein, users that attempt to subvert this user prompt can be detected and prevented from purchasing the restricted item without authorization.

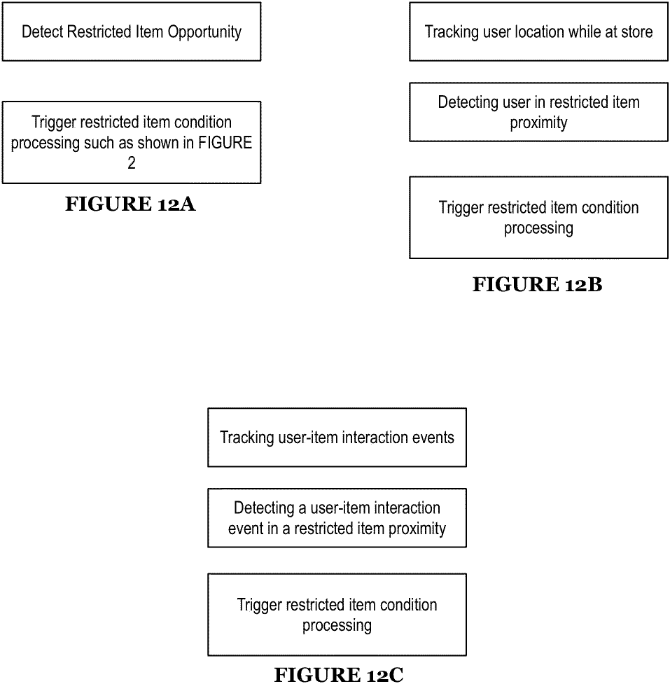

Some method variations or additional processing sequence flows of the method may use automated assertions or conditions in place of a user assertion. As described herein, there may be alternative variations where authorization processing may be triggered based on events other than a user assertion. As described below and shown in FIGS. 12A-12C, the monitoring system may detect special conditions that trigger when a prompt is displayed and/or when authorization is required. For example, a prompt may be dynamically displayed for users that walked through a section of the store with restricted items and/or performed interactions that possibly involved restricted items. In another example, a user that never was in proximity to a restricted item in the store, may be automatically determined to not need to assert. In yet another example, detection of likely selection of a restricted item may trigger authorization process. Accordingly, such variations block S120 may include dynamically determining restricted item assertion based in part on potential restricted item condition. More specifically, this can include processing the sensor data and thereby determining potential restricted item condition as part of S110; and then dynamically prompting in a user interface (e.g., for user assertion, to proceed with checkout without needing to assert, to complete authorization, etc.) based on potential restricted item condition.

Block S130, which includes determining compliance between the restricted item assertion and the virtual cart, functions to perform an automated check that the authorization state of items in the virtual cart is in compliance. As shown in FIG. 4, compliance verification may be performed for a cart regardless of prior authorization. This full verification may be used when different forms of restrictions exist. In some cases however, if a user has performed restricted item authorization, it may enable digital checkout processing without performing any compliance. This may be used, for example, in situation where authorization for one product enables authorization for any other restricted item.

Determining compliance includes determining if a restricted item is present in the cart items. If a restricted item is present, then the system may confirm state of authorization for that user account. If authorization has been satisfactorily completed, then the corresponding restricted item is in compliance. If authorization has not been completed or has an issue, then the restricted item is out of compliance (e.g., in violation of compliance).

In some variations, determining compliance may depend on a complete set of cart items to be output from the monitoring system. In another variation, determining compliance may be performed while items are determined for a cart item (i.e., the full cart does not yet need to be generated).

In the method variation, where the method is used as an auditing / monitoring tool for another checkout system, determining compliance may be used to check compliance for restricted items, but may also be used to detect discrepancies or differences between the checkout list from the checkout station and that determined using the monitoring system. Compliance issues may be stored in a report with association with the checkout station, optionally a worker identifier, optionally a customer identifier, and/or any other related data. This may be used to detect trends or patterns across different compliance issues.

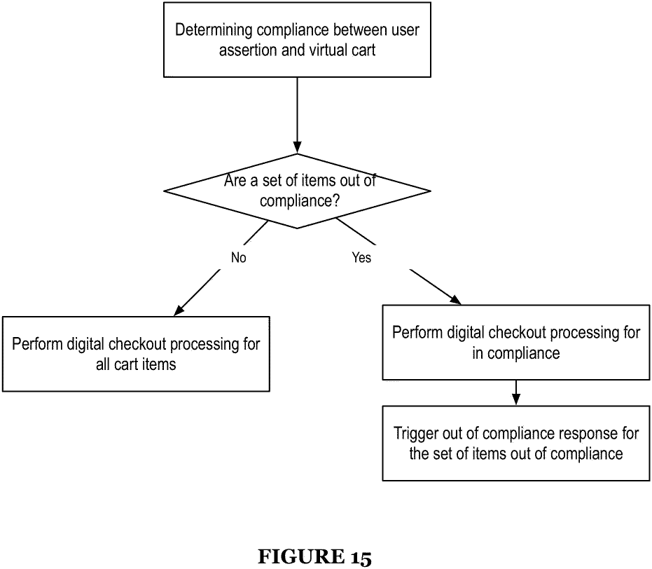

Block S140, which includes perform digital checkout processing of cart items according to compliance, functions to proceed with checkout processing in a way that address items out of compliance. For the processing items that are in compliance and out of compliance, block S140 may include generating a digital checkout cart of items determined to be in compliance and/or triggering a resolution flow for items of virtual cart determined to not be in compliance. As shown in FIG. 15, this can include selectively executing: a) if the set of cart items are in compliance, performing digital checkout processing for all cart items or b) if one or more items are out of compliance, performing digital checkout processing for a set of items that are in compliance (e.g., the non-restricted items and any items authorization) and then triggering an out of compliance response for the one or more items out of compliance.

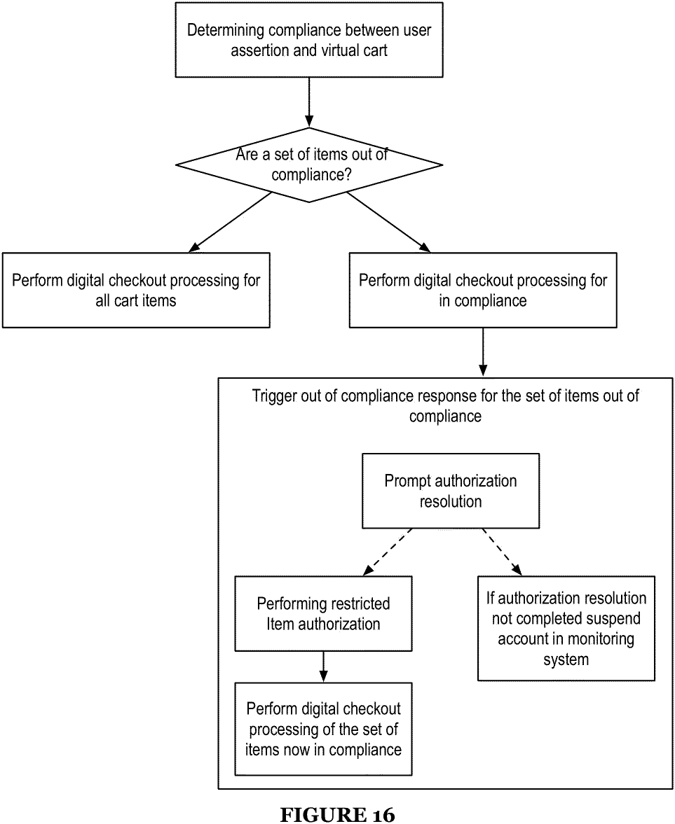

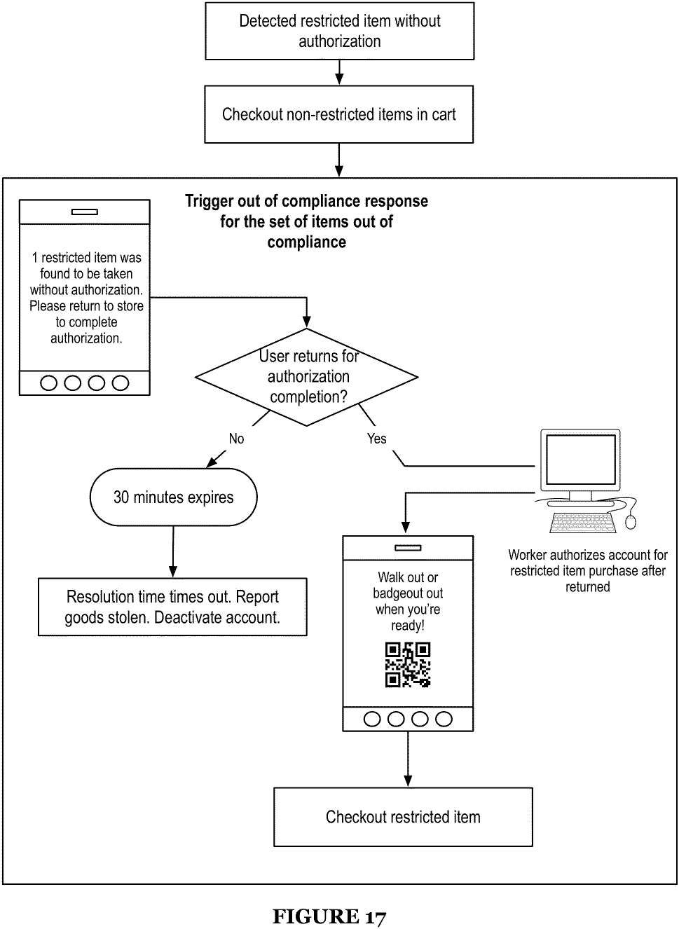

When items are not in compliance, the method may, in some variations, simply prevent checkout processing and notify the user of the issue and delegate resolution to them. In some variations, the method can enable the system to facilitate automation or at least partial automation to resolve the issue. A shown in FIG. 16, when items are out of compliance, the S140 may include triggering an out-of-compliance response for the set of items out of compliance. If it was an unintentional error (or whenever the user wishes to resolve the issue), the user may be notified via the client application or through some digital communication of how to resolve the authorization issue of the select items. The user for example could return to the store, and the worker could perform authorization (as described herein) of the restricted items still pending checkout processing. Once authorization is completed, then these restricted items may be processed for checkout since they would then be in compliance. Alternatively, in a scenario where the user never resolves the issue, then the items may be accounted as loss to the store. The system could update the associated user account to be in a suspended or banned state. In this way the system can prevent the user from subsequently using the system. As shown in FIG. 17, the user may be allotted 30 minutes before the account is deactivated and items reported stolen within the system. Different options may exist to resolve the issues with the user account.

The method may additionally or alternatively include other ways of addressing checkout processing of carts potentially including a restricted item. In some cases, these methods may be used in combination or independent of the method described above. In these method variations, the monitoring system may be used so that outputs of the monitoring can be used in augmenting the checkout process. In particular, outputs with sufficiently low latency may be used to detect conditions and scenarios where restricted items are possibly part of a cart or likely not part of a cart.

As shown in FIG. 12A, one method variation can include detecting a restricted item opportunity for a user and triggering restricted item condition processing. This restricted item condition processing may be used to determine when a user assertion is needed or when a user assertion is not likely needed. This method variation may be used to reduce friction by prompting a user assertion selectively in scenarios where it may be needed, but in cases where it is not needed allowing the user to skip this step in the flow.

Accordingly, such method variations may include processing the sensor data and thereby determining potential restricted item condition; and dynamically prompting for user assertion based on potential restricted item condition S1120. Dynamically prompting may include automatically asserting that there are no restricted items in the virtual cart when indicated by the potential restricted item condition; automatically requesting user assertion (e.g., if there is an occurrence of a potential restricted item condition or some other condition is met); and/or automatically asserting a potential restricted item condition. One or more of these different responses may be conditionally used. Determining compliance may still be performed in case there is a scenario where a restricted item was later determined to be in the virtual cart without proper authorization performed - S130 and S140 may be performed as described above with these method variations.

In particular this method variation may use user-location tracking and/or event detection as possible inputs to inform how authorization is prompted.

As shown in FIG. 12B, when using user-location tracking, the method variation can include tracking user location during a shopping visit, and triggering restricted item condition processing based on the user location. location may be used to determine user location relative to a map of the store, in which case the method may include processing the sensor data to determine user location in the environment and determining the potential restricted item condition based in part on user location. If a user enters a region marked as a restricted item region (e.g., the alcohol aisle and directly adjacent sections of a store), then the user may be flagged as needing to assert they don’t have an alcoholic item.

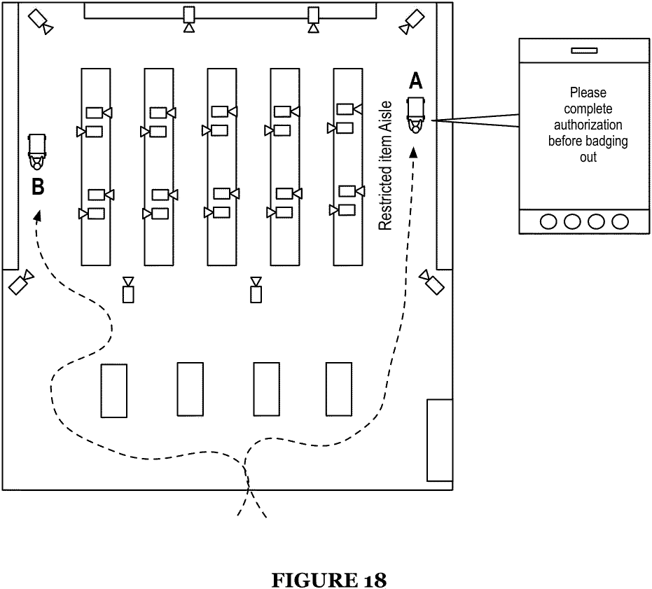

In other variations processing the sensor data and thereby determining potential restricted item condition may include: detecting location of user within a proximity threshold to a restricted item. This may more particularly include tracking user location during a shopping visit, detecting user in restricted item proximity, and triggering restricted item condition processing based on the restricted item proximity (if the user comes within some distance threshold (e.g., less than 3-6 feet) from the restricted item). If the user is detected to not have come in proximity to restricted items, then the method may opt to not prompt for a user assertion. As shown in FIG. 18, this may result in processing by the system to prompt user A for a user assertion because that user walked down an alcohol aisle, but user B may not be automatically prompted for a user assertion because that user only visited a region outside of some proximity threshold (e.g., user B only visited produce section and so very likely did not have a restricted item). User location tracking may be used since user tracking can be a low latency output of the monitoring system. For example, a CV person tracking module may output user location with low latency such that data signals are output during a shopping visit.

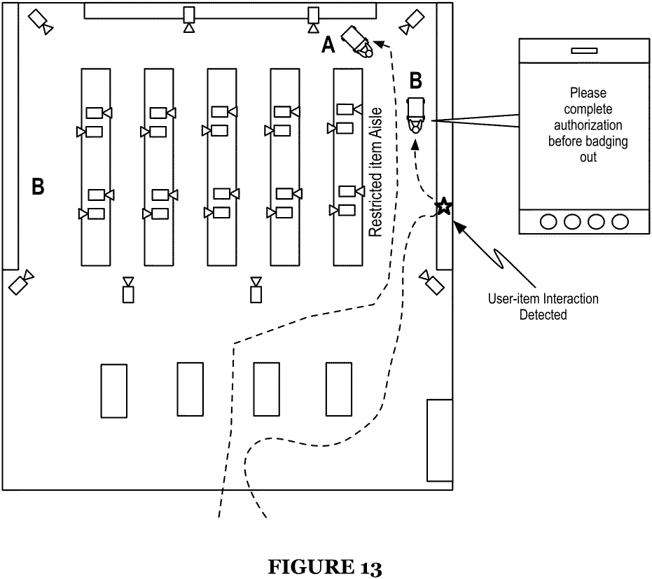

As shown in FIG. 12C, when using event detection, the method variation can include tracking user-item interaction events during a shopping visit, detecting a user-item interaction event possibly with a restricted item (e.g., event location being within some proximity to a restricted item) and triggering restricted item condition processing based on the user-item interaction event. The detected user-item interaction event will preferably involve the user with a restricted item (or a potential restricted item). This example can use an additional or alternative output of the monitoring system. It may be used with user-location tracking, with another monitoring output, or by itself. This may be used, for example, so that user-item selection events performed in regions of the store with a restricted items are used. This may enable, as shown example of FIG. 13, a user A to walk down an alcohol aisle but who does not perform a pickup action to avoid being prompted for a user assertion. On the other hand, user B of this example, may be prompted to perform some user assertion because a pick up event was performed in the alcohol aisle.

In one particular implementation, restricted items may be stored in special sensor-enables shelves that trigger an event when an item is removed from the shelf. When used in combination with a customer location tracking system (e.g., using CV tracking or device tracking), then all customers within some distance threshold may be flagged as potentially possessing an alcoholic item.

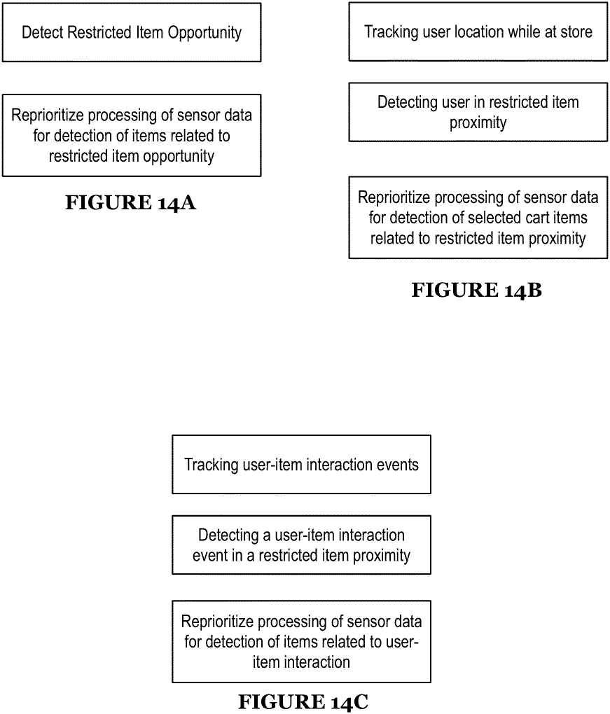

As shown in FIGS. 14A-14C, an additional or alternative variation may similarly use monitoring system outputs to alter processing of collected data. This may be used to accelerate evaluation of conditions that may warrant triggering a user assertion or even confirming that user authorization must be performed for a selected item. This variation can alter the processing of sensor data within a monitoring system to enable an enhanced user experience and/or to better meet compliance with item restrictions.

As shown in FIG. 14A, one such method variation can include detecting a restricted item opportunity for a user and augmenting processing of collected sensor data. This may be used to reprioritize processing of sensor data for detection of items related to a restricted item opportunity. Accordingly, such a variation may include detecting restricted-item related sensor data; and within a data-processing pipeline used in processing sensor data, prioritizing processing of the restricted-item related sensor data ahead of set of sensor data not related to restricted-items and generating a restricted-item cart assessment. In other words, certain events may result in the monitoring accelerating processing of data to determine if select portions of collected data indicate that a user picked up a restricted item. For example, a user may pick up 20 items with the 10th item being a restricted item. If processed sequentially, the virtual cart may not be generated during the shopping visit. However, detecting that a user location and/or a use-item interaction event occurred may enable the method to predictively process related data early so that the 10th item is processed and analyzed early so that it can be optimistically determined if that user possesses a restricted item or possibly possesses a restricted item. In implementation, this may be done by detecting when interactions occur with potential restricted items. In another implementation, sensor data from predefined regions that are known to contain restricted items may be automatically prioritized above sensor data from regions without restricted items.

As shown in FIG. 14B, such a method variation may be used with location and include tracking user location during a shopping visit, detecting user in restricted item proximity, and reprioritizing processing of sensor data for detection of selected cart items related to restricted item proximity.

As shown in FIG. 14C, such a method variation may be additionally or alternatively be used with event detection and include tracking user-item interaction events during a shopping visit, detecting a user-item interaction event possibly with a restricted item (e.g., event location being within some proximity to a restricted item) and reprioritizing processing of sensor data for detection of selected cart items related to restricted item proximity.

In some variations, the method may trigger user feedback so that a user is aware of certain conditions relating to their activity. Accordingly, the method may include presenting a processing status within a client device based on processing of the processing of the restricted-item related sensor data (e.g., an application on a computing device of the user). This can be used in method variations where restricted item sensor data is prioritized for processing. For example, in scenarios where a restricted item opportunity is detected, a user interface of a client device (e.g., a user device or a shared environment-installed device) may be updated with feedback regarding processing activity restricting next steps. For example, this can include showing in a user interface timer/progress of processing as shown in FIG. 10. This may be performed or triggered when a user walks down an aisle with restricted items and the sensor data is being proactively analyzed.

In the method, there may be various alternative interaction flows and interaction sequences to account for various features. As one example, the method may include providing an option for proactively opting in for authorization of satisfying restricted item conditions. For example, a customer could with alcohol could opt to have a worker confirm their ID so that they can complete checkout. This may be performed without completing a user assertion prompt and as a result eliminate the need for prompting for a user assertion.

### 3. System

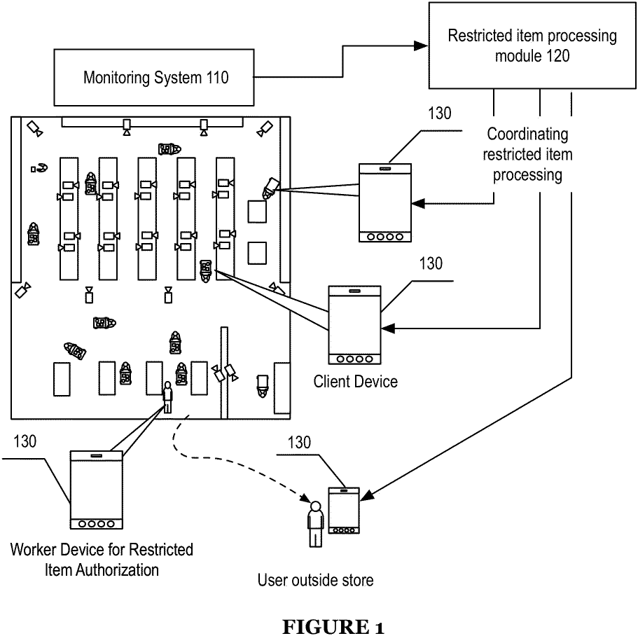

As shown in FIG. 1, a system for automating processing of restricted items can include a monitoring system 110 with a data output characterizing cart items of a user (e.g., a virtual cart), a restricted item processing module 120 that manages data systems and coordinated digital interactions for enforcing a compliance policy for one or more restricted items. The method may additionally include one or more client devices 130 which may be applications instantiated on personal computing device or computing devices present in the environment.

The system can interface or include one or more different client devices 130. The client devices could include user interfaces for customers and/or workers. The client devices could be or include user devices such as smart phones, smart watch, smart headphones, AR/smart glasses, or other type of mobile personal computing device. The client devices could alternatively be or include a shared environment-installed client device like a kiosk. For example, a retail store may include one or more kiosks used by users of an automated checkout system to badge-out or check-in during a shopping visit. The client devices can include one or more user interfaces that are rendered or presented as part of an application or device service (e.g., a messaging app or notification system). The user application can be used for viewing virtual cart state and/or checkout receipts, for interacting with user assertion prompts, badging in or out, or otherwise interacting with an automated checkout service of the system.

System may include or interface with a product data system where item data records include data that indicate restricted conditions. Data records can model if items have restrictions and optionally the type of restriction (if there are different types of restrictions. In some implementations, each individual item may be modeled with a restriction property. In another implementation, restrictions may be associated with particular product categories or tags, and products may be assigned one or more categories. For example, items with a particular item category may be processed as restricted. Any suitable approach to modeling restrictions of products may alternatively be used with a product data system.

The restricted item processing module 120 functions to manage processing restricted items. The restricted item processing module 120 can include configuration of conditional logic for processing conditions of select types of products.

The restricted item processing module 120 in connection with a client device used by the user can initiate a user interface for collecting a user assertion. The restricted item processing module 120 interfaces with the monitoring system 110 to use detected state, activity and cart items of a user for appropriately processing restricted items.

The restricted item processing module 120 may manage storing received authorization for a particular user. For example, a worker may enter or confirm within a connected computing device that a user has authorization for purchase of age-restricted items.

The restricted item processing module 120 can additionally include logic to determine compliance of a virtual cart of a user with the user assertion and/or authorization for that user.

The restricted item processing module 120 can additionally include interface to a checkout processing system through which checkout processing requests can be made based on results of item compliance.

Checkout processing system is preferably used in combination with the restricted item processing module 120 and monitoring system 110. For a given shopping visit of a user, select items that are determined at least in part by the monitoring system 110 can be processed using the checkout processing system.

The monitoring system 110 functions to generate or determine cart items of users within an environment. The monitoring system 110 can manage detection and determination of cart items for multiple users in an environment at the same time.

The monitoring system 110 may include one or more different sensing systems and processing modules such as image-based monitoring system, smart shelf monitoring system, RFID monitoring system, hybrid / sensor-fusion monitoring systems, scan-and-shop user application systems, and/or other types of monitoring systems. As one detailed example, the system may be used with an image-based monitoring system, additional or alternative sensing systems may be used with similar or corresponding signal outputs regarding user locations, user-item interactions, item/product identification, virtual cart state, and/or other detected outputs.

An image-based monitoring system (e.g., a CV monitoring system) of a preferred embodiment functions to transform image data collected within the environment into observations relating in some way to products in the environment. Preferably, the CV monitoring system is used for detecting products, monitoring users, tracking user-product interactions, and/or making other conclusions based on image and/or sensor data. The CV monitoring system will preferably include various computing elements used in processing image data collected by an imaging system. In particular, the CV monitoring system will preferably include an imaging system and a set of modeling processes and/or other processes to facilitate analysis of user actions, product state, and/or other properties of the environment.

The CV monitoring system is preferably configured to facilitate identifying of products, the locations of products relative to various shelf-space locations, and/or detection of interactions associated with identified products.

The CV monitoring system preferably provides specific functionality that may be varied and customized for a variety of applications. In addition to product identification, the CV monitoring system may additionally facilitate operations related to person identification, virtual cart generation, product interaction tracking, store mapping, and/or other CV-based observations. Preferably, the CV monitoring system can at least partially provide person detection; person identification; person tracking; object detection; object classification; object tracking; gesture, event, or interaction detection; detection of a set of customer-product interactions, and/or other forms of information.

In one preferred embodiment, the system can use a CV monitoring system and processing system such as the one described in the published U.S. Pat. Application 2017/0323376 filed on May 9, 2017, which is hereby incorporated in its entirety by this reference. The CV monitoring system will preferably include various computing elements used in processing image data collected by an imaging system.

The imaging system functions to collect image data within the environment. The imaging system preferably includes a set of image capture devices. The imaging system might collect some combination of visual, infrared, depth-based, lidar, radar, sonar, and/or other types of image data. The imaging system is preferably positioned at a range of distinct vantage points. However, in one variation, the imaging system may include only a single image capture device. In one example, a small environment may only require a single camera to monitor a shelf of purchasable products. The image data is preferably video but can alternatively be a set of periodic static images. In one implementation, the imaging system may collect image data from existing surveillance or video systems. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system preferably includes a set of static image devices mounted with an aerial view from the ceiling or overhead. The aerial view imaging devices preferably provide image data that observes at least the users in locations where they would interact with products. Preferably, the image data includes images of the products and users (e.g., customers or workers). While the system (and method) is described herein as they would be used to perform CV as it relates to a particular product and/or user, the systems and methods can preferably perform such functionality in parallel across multiple users and multiple locations in the environment. Therefore, the image data may collect image data that captures multiple products with simultaneous overlapping events. The imaging system is preferably installed such that the image data covers the area of interest within the environment.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system may have an imaging system with only partial coverage within the environment.

A CV-based processing engine and data pipeline preferably manages the collected image data and facilitates processing of the image data to establish various conclusions. The various CV-based processing modules are preferably used in generating user-product interaction events, a recorded history of user actions and behavior, and/or collecting other information within the environment. The data processing engine can reside local to the imaging system or capture devices and/or an environment. The data processing engine may alternatively operate remotely in part or whole in a cloud-based computing platform.

The product detection module of a preferred embodiment, functions to detect and apply an identifier to an object. The product detection module preferably performs a combination of object detection, segmentation, classification, and/or identification. This is preferably used in identifying products or products displayed in a store. Preferably, a product can be classified and associated with a product SKU (stock keeping unit) identifier. In some cases, a product may be classified as a general type of product. For example, a carton of milk may be labeled as milk without specifically identifying the SKU of that particular carton of milk. An object tracking module could similarly be used to track products through the store.

In a successfully trained scenario, the product detection module properly identifies a product observed in the image data as being associated with a particular product identifier. In that case, the CV monitoring system and/or other system elements can proceed with normal processing of the product information. In an unsuccessful scenario (i.e., an exception scenario), the product detection module fails to fully identify a product observed in the image data. An exception may be caused by an inability to identify an object, but could also be other scenarios such as identifying at least two potential identifiers for a product with sufficiently close accuracy, identifying an product with a confidence below a certain threshold, and/or any suitable condition whereby a remote product labeling task could be beneficial. In this case the relevant image data is preferably marked for labeling and/or transferred a product mapping tool for human assisted identification.

As described below, the product detection module may use information from detected physical labels to assist in the identification of products.

The product detection module in some variations may be integrated into a product inventory system. The product inventory system functions to detect or establish the location of inventory/products in the environment. The product inventory system can manage data relating to higher level inventory states within the environment. For example, the inventory system can manage a location/position product map, which could be in the form of a planogram. The planogram may be based partially on the detected physical labels. The inventory system can preferably be queried to collect contextual information of a identified product such as nearby products.

User-product interaction processing modules function to detect or classify scenarios of users interacting with a product (or performing some gesture interaction in general). User-product interaction processing modules may be configured to detect particular interactions through other processing modules. For example, tracking the relative position of a user and product can be used to trigger events when a user is in proximity to a product but then starts to move away. Specialized user-product interaction processing modules may classify particular interactions such as detecting product grabbing or detecting product placement in a cart. User-product interaction detection may be used as one potential trigger for a product detection module.

A person detection and/or tracking module functions to detect people and track them through the environment.

A person identification module can be a similar module that may be used to uniquely identify a person. This can use biometric identification. Alternatively, the person identification module may use Bluetooth beaconing, computing device signature detection, computing device location tracking, and/or other techniques to facilitate the identification of a person. Identifying a person preferably enable customer history, settings, and preferences to be associated with a person. A person identification module may additionally be used in detecting an associated user record or account. In the case where a user record or account is associated or otherwise linked with an application instance or a communication endpoint (e.g., a messaging username or a phone number), then the system could communicate with the user through a personal communication channel (e.g., within an app or through text messages).

A gesture, event, or interaction detection modules function to detect various scenarios involving a customer. One preferred type of interaction detection could be a customer attention tracking module that functions to detect and interpret customer attention. This is preferably used to detect if, and optionally where, a customer directs attention. This can be used to detect if a customer glanced in the direction of a product or even if the product was specifically viewed. A location property that identifies a focus, point, or region of the interaction may be associated with a gesture or interaction. The location property is preferably 3D or shelf location “receiving” the interaction. An environment location property on the other hand may identify the position in the environment where a user or agent performed the gesture or interaction.

Alternative forms of CV-based processing modules may additionally be used such as customer sentiment analysis, clothing analysis, customer grouping detection (e.g., detecting families, couples, friends, or other groups of customers that are visiting the store as a group), and/or the like. The system may include a number of subsystems that provide higher-level analysis of the image data and/or provide other environmental information such as a real-time virtual cart system.

The real-time virtual cart system functions to model the products currently selected for purchase by a customer. The virtual cart system may enable automatic self-checkout or accelerated checkout. Product transactions could even be reduced to per-product transactions (purchases or returns based on the selection or de-selection of a product for purchase).

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., a non-transitory computer-readable medium) storing instructions that, when executed by the one or more computer processors, cause a computing platform to perform operations comprising those of the system or method described herein such as: determining cart items; determining user assertion regarding restricted items; determining compliance between user assertion and virtual cart; and performing digital checkout processing of cart items according to compliance.

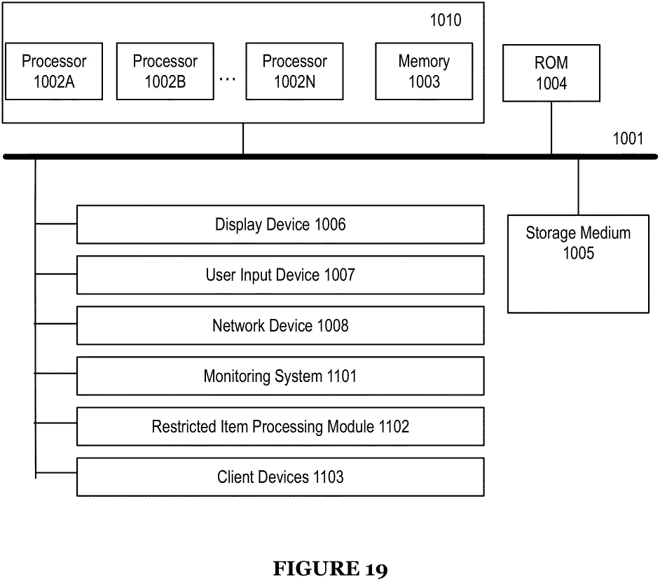

FIG. 19 is an exemplary computer architecture diagram of one implementation of the system. In some implementations, the system is implemented in a plurality of devices in communication over a communication channel and/or network. In some implementations, the elements of the system are implemented in separate computing devices . In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting monitoring system 1101, restricted item processing module 1102, client devices 1103, and/or other suitable computing devices.

The processors 1002A-1002N may take many forms, such CPUs (Central Processing Units), GPUs (Graphical Processing Units), microprocessors, ML/DL (Machine Learning / Deep Learning) processing units such as a Tensor Processing Unit, FPGA (Field Programmable Gate Arrays, custom processors, and/or any suitable type of processor.

The processors 1002A-1002N and the main memory 1003 (or some subcombination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method comprising:
collecting, using a sensor-based monitoring system, sensor data of user interactions within an environment;
processing the sensor data and thereby determining cart items for a virtual cart of a first user;
determining a restricted item assertion regarding restricted items intended for purchase by user and presenting the assertion within a user interface of a client device;
determining compliance between the restricted item assertion and the virtual cart; and
performing digital checkout processing of cart items according to the compliance.

2. The method of claim 1, wherein processing the sensor data comprises: detecting restricted-item related sensor data, prioritizing processing of the restricted-item related sensor data ahead of a set of sensor data not related to restricted-items, and generating a restricted-item cart assessment; and wherein determining the restricted item assertion is based at least in part on the restricted-item cart assessment.

3. The method of claim 2, further comprising presenting a processing status within the client device based on status of processing the restricted-item related sensor data.

4. The method of claim 1, wherein processing the sensor data comprises determining a potential restricted item condition; and wherein determining the restricted item assertion comprises dynamically prompting for a user input when setting the restricted item assertion.

5. The method of claim 4, wherein dynamically prompting for a user input compute comprises performing one of the set of processing options: automatically asserting that there are no restricted items in the virtual cart when indicated by the potential restricted item condition, automatically requesting user assertion if there is an occurrence of a potential restricted item condition, and automatically asserting a potential restricted item condition.

6. The method of claim 1, further comprising after receiving assertion of restricted items in the virtual cart, enabling checkout processing of restricted items upon receiving confirmation of age.

7. The method of claim 6, further comprising collecting identity verification of the first user, collecting a biometric signature of the first user, mapping the identity verification to the biometric signature of the first user, and wherein receiving confirmation of age comprises confirming the biometric signature of the first user.

8. The method of claim 1, wherein performing digital checkout processing of cart items according to the compliance comprises generating a digital checkout cart of items determined to be in compliance and triggering a resolution flow for items of virtual cart determined to not be in compliance.

9. A non-transitory computer-readable medium storing instructions that, when executed by one or more computer processors of a computing platform, cause the computing platform to:
collecting, using a sensor-based monitoring system, sensor data of user interactions within an environment;
processing the sensor data and thereby determining cart items for a virtual cart of a first user;
determining a restricted item assertion regarding restricted items intended for purchase by user and presenting the assertion within a user interface of a client device;
determining compliance between the restricted item assertion and the virtual cart; and
performing digital checkout processing of cart items according to the compliance.

10. The non-transitory computer-readable medium of claim 9, wherein processing the sensor data comprises: detecting restricted-item related sensor data, prioritizing processing of the restricted-item related sensor data ahead of a set of sensor data not related to restricted-items, and generating a restricted-item cart assessment; and wherein determining the restricted item assertion is based at least in part on the restricted-item cart assessment.

11. The non-transitory computer-readable medium of claim 10, further comprising presenting a processing status within the client device based on status of processing the restricted-item related sensor data.

12. The non-transitory computer-readable medium of claim 9, wherein processing the sensor data comprises determining a potential restricted item condition; and wherein determining the restricted item assertion comprises dynamically prompting for a user input when setting the restricted item assertion.

13. The non-transitory computer-readable medium of claim 12, wherein dynamically prompting for a user input compute comprises performing one of the set of processing options: automatically asserting that there are no restricted items in the virtual cart when indicated by the potential restricted item condition, automatically requesting user assertion if there is an occurrence of a potential restricted item condition, and automatically asserting a potential restricted item condition.

14. The non-transitory computer-readable medium of claim 9, further comprising after receiving assertion of restricted items in the virtual cart, enabling checkout processing of restricted items upon receiving confirmation of age.

15. The non-transitory computer-readable medium of claim 9, wherein performing digital checkout processing of cart items according to the compliance comprises generating a digital checkout cart of items determined to be in compliance and triggering a resolution flow for items of virtual cart determined to not be in compliance.

16. A system comprising of:
• one or more computer-readable mediums storing instructions that, when executed by the one or more computer processors, cause a computing platform to perform operations comprising:
collecting, using a sensor-based monitoring system, sensor data of user interactions within an environment;
processing the sensor data and thereby determining cart items for a virtual cart of a first user;
determining a restricted item assertion regarding restricted items intended for purchase by user and presenting the assertion within a user interface of a client device;
determining compliance between the restricted item assertion and the virtual cart; and
performing digital checkout processing of cart items according to the compliance.

17. The system of claim 16, wherein processing the sensor data comprises: detecting restricted-item related sensor data, prioritizing processing of the restricted-item related sensor data ahead of a set of sensor data not related to restricted-items, and generating a restricted-item cart assessment; and wherein determining the restricted item assertion is based at least in part on the restricted-item cart assessment.

18. The system of claim 16, wherein processing the sensor data comprises determining a potential restricted item condition; and wherein determining the restricted item assertion comprises dynamically prompting for a user input when setting the restricted item assertion.

19. The system of claim 16, further comprising after receiving assertion of restricted items in the virtual cart, enabling checkout processing of restricted items upon receiving confirmation of age.

20. The system of claim 16, wherein performing digital checkout processing of cart items according to the compliance comprises generating a digital checkout cart of items determined to be in compliance and triggering a resolution flow for items of virtual cart determined to not be in compliance.
